(19) United States
(12) Patent Application Publication
(10) Pub. No.: US 2014/0182177 A1
(43) Pub. Date: Jul. 3, 2014

(54) ADVERTISING LIGHTBOX INCLUDING LED ARRAY POSITIONED IN FRONT OF A MULTIPLE PRISMATIC DIELECTRIC REFLECTOR

(71) Applicant: He Wang, Beijing (CN)

(72) Inventor: He Wang, Beijing (CN)

(21) Appl. No.: 13/732,400

(22) Filed: Jan. 1, 2013

(51) Int. Cl. G09F 13/04

(52) U.S. Cl. CPC G09F 13/0413
USPC 40/564

(57) ABSTRACT

The disclosure relates to an advertising lightbox including a source of background lighting for a transparent or translucent panel, which includes advertisement indicia and/or graphics. The background light source includes an LED array that extends along a longitudinal axis. The light source also includes a reflector having a plurality of planar sections elongated substantially parallel with the longitudinal axis of the LED array. The elongated planar sections of the reflector are positioned on both sides of the LED array at different offset positions along a lateral axis, and are inclined at different angles of inclination in a positive vertical axis towards the panel. The desired illumination effect upon the advertisement panel depends on the type or characteristics of the LED array, the parameters (number of sections, angles of inclination, height, width, reflective material, etc.) of the reflector, and the distance between the panel and the LED array.

### FIELD

This invention relates generally to advertising light boxes, and in particular, to an advertising lightbox comprising a light emitting diode (LED) array positioned in front of a multiple prismatic dielectric reflector.

### BACKGROUND

Many advertising light boxes and other illuminating apparatuses include a source of background lighting. Generally, in the past, the background lighting source typically consisted of incandescent or fluorescent lighting elements. These lighting elements generally consume an undesirable amount of power. Thus, advertising light boxes and other apparatuses that use in incandescent or fluorescent background lighting sources typically are more expensive to operate, less environmentally friendly, and require more maintenance due to the relatively short life cycle of the illumination elements.

Because of these issues with incandescent and fluorescent background lighting sources, many advertising light boxes and other illuminating apparatus are now using light emitting diodes (LEDs) as the primary source of illumination. LEDs consume substantially less power; and thereby, are less costly to operate and are generally environmentally friendly. Additionally, due to the longer life cycle of LEDs, these types of lighting sources are generally easier to maintain.

Although LED light sources are useful in reducing the power required to operate advertising light boxes and other illuminating apparatuses, there is still a need for further reduction in the consumption of power of such apparatuses. Additionally, and in particular with respect to advertising light boxes, LED-based background lighting sources should be configured to provide a desired lighting effect including the desired balance, illumination, dispersement, coloring, and other lighting characteristics.

### SUMMARY

An aspect of the disclosure relates to an advertising lightbox comprising a source of background lighting for a transparent or translucent panel, which includes advertisement indicia and/or graphics. The background light source includes an LED array that extends along a longitudinal axis. The advertising lightbox also includes a reflector having a plurality of planar sections elongated substantially parallel with the longitudinal axis of the LED array. The elongated planar sections of the reflector are positioned on both sides of the LED array at different offset positions along a lateral axis, and are inclined at different angles of inclination in a positive vertical axis towards the panel. The desired illumination effect upon the advertisement panel depends on the type or characteristics of the LED array, the parameters (number of sections, angles of inclination, height, width, reflective material, etc.) of the reflector, and the distance between the panel and the LED array.

The background light source itself may be arrayed in the lateral and/or longitudinal axes directions depending on the size of the advertisement panel and the desired illumination effect. Another embodiment comprises a reflector with curved sections. Other aspects, advantages and novel features of the present invention will become apparent from the following detailed description of the invention when considered in conjunction with the accompanying drawings.

### BRIEF DESCRIPTION OF THE DRAWINGS

FIGS. 1A-1B illustrate top and side views of an exemplary advertising lightbox in accordance with an aspect of the disclosure.

FIGS. 2A-2B illustrate top and side views of another exemplary advertising lightbox in accordance with another aspect of the disclosure.

FIG. 3 illustrates a side view of another exemplary advertising lightbox in accordance with another aspect of the disclosure.

FIG. 4 illustrates a side view of another exemplary advertising lightbox in accordance with another aspect of the disclosure.

FIG. 5 illustrates a side view of another exemplary advertising lightbox in accordance with another aspect of the disclosure.

FIG. 6 illustrates a side view of another exemplary advertising lightbox in accordance with another aspect of the disclosure.

FIG. 7 illustrates a side view of another exemplary advertising lightbox in accordance with another aspect of the disclosure.

FIG. 8 illustrates a side view of another exemplary advertising lightbox in accordance with another aspect of the disclosure.

FIG. 9 illustrates a side view of another exemplary advertising lightbox in accordance with another aspect of the disclosure.

FIG. 10 illustrates a cross-sectional side view of an exemplary reflector section in accordance with another aspect of the disclosure.

FIGS. 11A-11B illustrate front and top views of an exemplary advertising lightbox in accordance with another aspect of the disclosure.

### DETAILED DESCRIPTION OF THE EXEMPLARY EMBODIMENTS

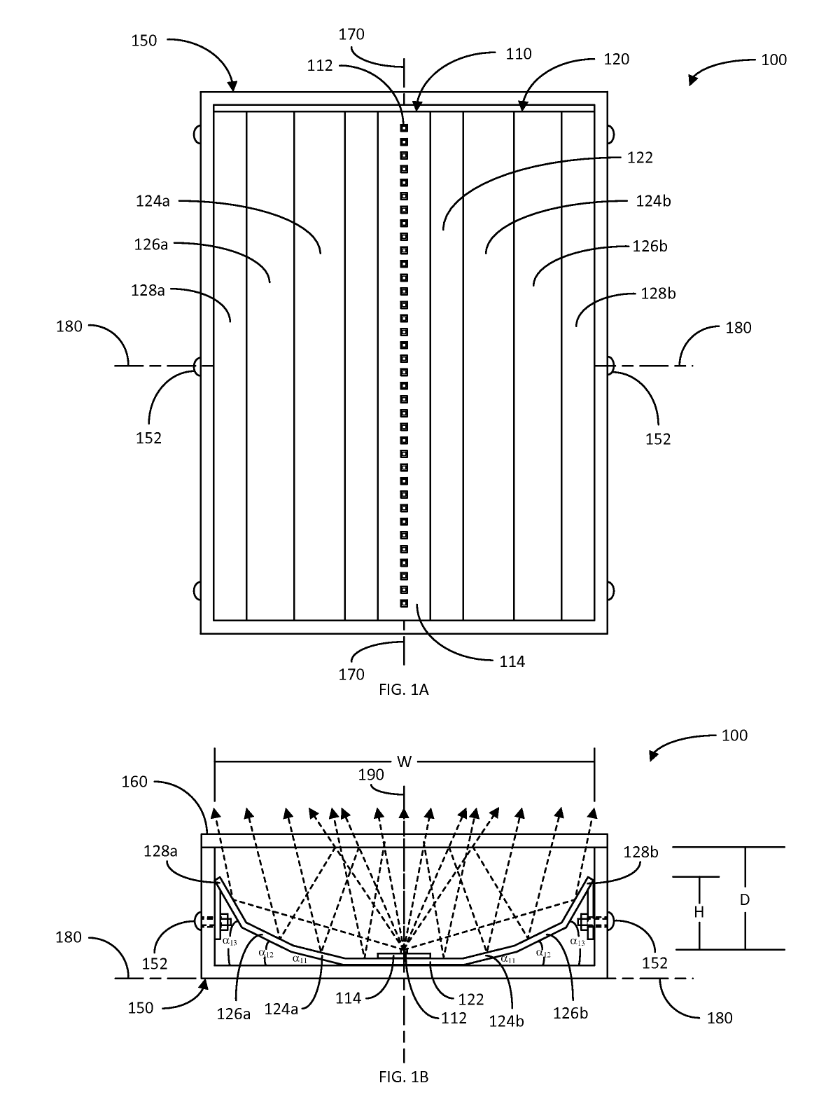

FIGS. 1A-1B illustrate top and side views of an exemplary advertising lightbox 100 in accordance with an aspect of the disclosure. In summary, the advertising lightbox 100 comprises an array of light emitting diodes (LEDs) that extend along a longitudinal (horizontal) axis, and a reflector situated under or behind the LED array, which is curved along a lateral (horizontal) axis and a positive vertical axis, and symmetrically about the positive vertical axis. The reflector may comprise a plurality of elongated planar sections that extend substantially parallel with longitudinal axis on both sides of the LED array, wherein each section, except for a centrally-located section under the LED array, is inclined along the lateral and vertical axes to form the curvature of the reflector.

In particular, the advertising lightbox 100 comprises a light assembly 110, a reflector assembly 120, a housing 150, a plurality of fasteners 152 for securely attaching the reflector assembly 120 to the housing 150, and an optically transparent or translucent panel 160. For example, the transparent or translucent panel 160 may include advertisement indicia and/or graphics thereon, including advertising pictures, photographs, and posters.

The light assembly 110, in turn, comprises a plurality of LEDs 112 disposed over and on an elongated plate 114. The LEDs 112 are arranged in a linear array that extends along a longitudinal (horizontal) axis 170. Consequently, the elongated plate 114 also extends longitudinally along the longitudinal (horizontal) axis 170 of the LED array 112. Although the longitudinal axis 170 is described as being oriented horizontally for description purposes, it shall be understood that the longitudinal axis 170 may extend in any direction depending on the orientation of the advertising lightbox 100. The elongated plate 114 may comprise a dielectric plate, a printed circuit board (PCB), or a metallic plate. Although, in this example, the longitudinal axis 170 is shown as a linear axis, it shall be understood that the longitudinal axis 170 may be a curved axis.

The reflector assembly 120, in turn, comprises a plurality of elongated planar sections 122, 124a-b, 126a-b, and 128a-b that extend longitudinally parallel with the longitudinal (horizontal) axis 170 of the LED array 112. The light assembly 110, and in particular, the elongated plate 114, is disposed substantially centrally and horizontally on the elongated centrally-located planar section 122 of the reflector assembly 120.

The elongated planar sections 124a-b of the reflector assembly 120 are situated on the immediate both sides of the central-located section 122 of the reflector assembly 120 along a lateral axis 180 and substantially symmetrical about the longitudinal axis 170. The elongated planar sections 124a-b are also inclined in a positive vertical direction 190 along the lateral axis 180 at substantially the same inclination angle α₁₁. Thus, the elongated planar sections 124a-b are substantially symmetrical about the longitudinal and vertical axes 170 and 190. The elongated planar section 124a-b may be separate, attached or integral with the centrally-located section 122 of the reflector assembly 120.

Similarly, the elongated planar sections 126a-b of the reflector assembly 120 are situated on the respective outward lateral sides of the elongated sections 124a-b of the reflector assembly 120 and substantially symmetrical about the longitudinal and vertical axes 170 and 190. The elongated planar sections 126a-b are also inclined in the positive vertical direction 190 along the lateral axis 180 at substantially the same inclination angle α₁₂, which is greater than the inclination angle α₁₁ of elongated sections 124a-b. The elongated planar section 126a-b may be separate, attached or integral with the elongated sections 124a-b of the reflector assembly 120, respectively.

In a like manner, the elongated planar sections 128a-b of the reflector assembly 120 are situated on the respective outward lateral sides of the elongated sections 126a-b of the reflector assembly 120 and substantially symmetrical about the longitudinal and vertical axes 170 and 190. The elongated planar sections 128a-b are also inclined in the positive vertical direction 190 along the lateral axis 180 at substantially the same inclination angle α₁₃, which is greater than the inclination angle β₁₂ of elongated sections 126a-b. The elongated planar section 128a-b may be separate, attached or integral with the elongated sections 126a-b of the reflector assembly 120, respectively.

The LED array 112 and the reflector assembly 120 may be configured to produce a desired illumination effect on the transparent or translucent panel 160. A desired illumination effect, for example, may be to provide substantially uniform lighting across the surface of the transparent or translucent panel 160. Another desired illumination effect, for example, may be to provide a desired light intensity or lumens across the surface of the transparent or translucent panel 160. Still, another desired illumination effect, for example, may be to provide a desired coloring (e.g., color temperature, whiteness, hue, etc.) across the surface of the transparent or translucent panel 160.

As an example, the desired illumination effect upon the panel 160 may be to provide uniform lighting or lumens across the surface area of the panel. For instance, light or lumen uniformity may be defined as follows:

Uniformity=1−[(Maximum brightness−Minimum brightness)/Multi point average brightness]*100%

For instance, a uniformity of 90% or greater requires that the difference between the maximum brightness and the minimum brightness divided by a multipoint average brightness should be 0.1 or less. The parameters of the lightbox 100 as discussed below may be configured to provide a uniformity across the panel 160 of 90% or greater.

Another example of a desired illumination effect upon the panel 160 may be to provide an accurate color rendering of the panel. For example, the advertising lightbox 100 may be configured to provide, as close as possible, a 100% pure white color rendering of the panel 160. For instance, in accordance with the International Commission on Illumination (CIE) color space, a 100% pure white color rendering may be defined as having a CIE X value of 0.333 and a CIE Y value of 0.333. Thus, the parameters of the lightbox 100 as discussed below may be configured to provide the desired color rendering of the panel 160.

Another related objective is to provide the desired illumination effect while using a minimum number of LEDs. This is done in order to reduce the amount of power consumed by the lightbox 100. Thus, the parameters of the lightbox 100 may be configured to provide the desired illumination effect upon the panel 160 by, for example, using a maximum distance between LED in order to put less LED chips into the lightbox. Again, this saves energy and reduces the costs to maintain the lightbox.

Thus, in summary, the lightbox 100 and all other light boxes described herein may be configured to provide the desired illumination effect, including advertisement picture uniformity, substantially accurate advertising color rendering, while using a minimum number of LEDs in order to conserve energy and reduce maintenance costs.

The desired illumination effect may depend on many parameters. For instance, the desired illumination effect may depend on the type (i.e., characteristics) of the LEDs of the LED array 112. These characteristics include the light intensity or lumens per watt emitted by each LED, the color temperature emitted by each LED, the dispersion angle of each LED, and other optical properties of each LED. The desired illumination effect may also depend on parameters of the LED array 112. These parameters may include the spacing between adjacent LEDs of the array, the positioning (linear, serpentine, pseudorandom, etc.) of the LEDs of the array, the orientation of the LEDs of the array, whether the array includes the same type LEDs or a mixture of different types of LEDs, and other optical properties of the LED array 112.

The desired illumination effect may also depend on parameters of the reflector assembly 120. These parameters may include the reflectance of the materials used for the elongated planar sections 122, 124a-b, 126a-b, and 128a-b; the angles of inclination α₁₁, α₁₂, and α₁₃ of the elongated planar sections 124a-b, 126a-b, and 128a-b; the vertical height H, with respect to the LED array 112, of the top of the reflector assembly 120; the width W of the reflector assembly 120; and other optical properties of the reflector assembly. The desired illumination effect may also depend on parameters of the transparent or translucent panel 160. These parameters may include the distance D between the panel 160 and the LED array 112; the width W of the panel 160; the translucent, transparent, reflectance and other optical properties of the material used for the panel 160.

Another aspect of the reflector assembly 120 is whether the different sections 122, 124a-b, 126a-b, and 128a-c are configured for primary reflection or secondary reflection. A section is configured for primary reflection if it receives the light directly from the LED array 112. A section is configured for secondary reflection if it receives light originating from the LED array 112 by way of another reflective surface. A section may include a first region for performing primary reflection of light emitted by the LED array 112 and a second region for performing secondary reflection of light emitted by the LED array 112. This is better explained below with reference to the reflector assembly 120 of advertising lightbox 100.

In particular, the sections 128a and 128b of the reflector assembly 120 are configured to perform at least primary reflection of the light emitted by the LED array 112. For instance, the rays of light emitted by the LED array 112, represented by the dashed arrow line, that strike the sections 128a-b represent the boundary of the light dispersion from the LED array 112 (e.g., with a dispersion angle of about 120 degrees). Since these rays of light do not reflect off another surface before striking sections 128a-b, the sections 128a-b are configured for performing at least primary reflection of the light emitted by LED array 112.

Note, that the angle of inclination α₁₃ of sections 128a-b is configured to cause the sections to reflect light upwards towards the panel 160 at a particular angle to achieve the desired illumination effect. Also, note that since the rays of light striking sections 128a-b represent the boundary of the light dispersion of the LED array 112, an upper region of the sections 128a-b are configured for performing at least primary reflection of the light emitted from the LED array 112, and a lower region of the sections 128a-b are not configured for performing primary reflection of the light emitted from the LED array 112, but are configured for performing secondary reflection of light originating from the LED array 112 that reflected off, for example, the lower surface of the transparent or translucent panel 160.

The other sections 122, 124a-b, and 126a-b of the reflector assembly 120 are not configured for performing primary reflection of the light emitted from the light array 112, but are configured for performing at least secondary reflection of the light emitted from the LED array 112. That is, the sections 122, 124a-b, and 126a-b are positioned below or outside of the boundary of the light dispersion from the LED array 112. These sections 122, 124a-b, and 126a-b are configured for secondary reflections of light from the light array 112 that has reflected off the lower surface of the transparent or translucent panel 160.

For instance, section 122 is configured to reflect secondary light that has reflected off a central region (the region immediately above the light array 112) of the lower surface of the panel 160. Whereas, the sections 124a-b, and 126a-b are configured to reflect secondary light that has reflected off the lower surface of the panel 160 at regions further away in the lateral direction from the vertical axis 190 of the light array 112, respectively. The angles of inclination α₁₁ and α₁₂ of the sections 124a-b and 126a-b are configured to reflect the secondary light towards the panel 160 at particular angles to achieve the desired illumination effect.

Although, in this example, the reflector assembly 120 has been illustrated as being symmetrical about the vertical axis 190 of the LED array 112 (i.e., the angles α₁₁, α₁₂, and α₁₃ are the same for the respective section pairs 124a-b, 126a-b, and 128a-b), it shall be understood that the reflector assembly 120 may also be configured to be asymmetrical about the vertical axis 190 (i.e., the angles α₁₁, α₁₂, and α₁₃ are not the same for the respective section pairs 124a-b, 126a-b, and 128a-b), depending on the desired illumination effect.

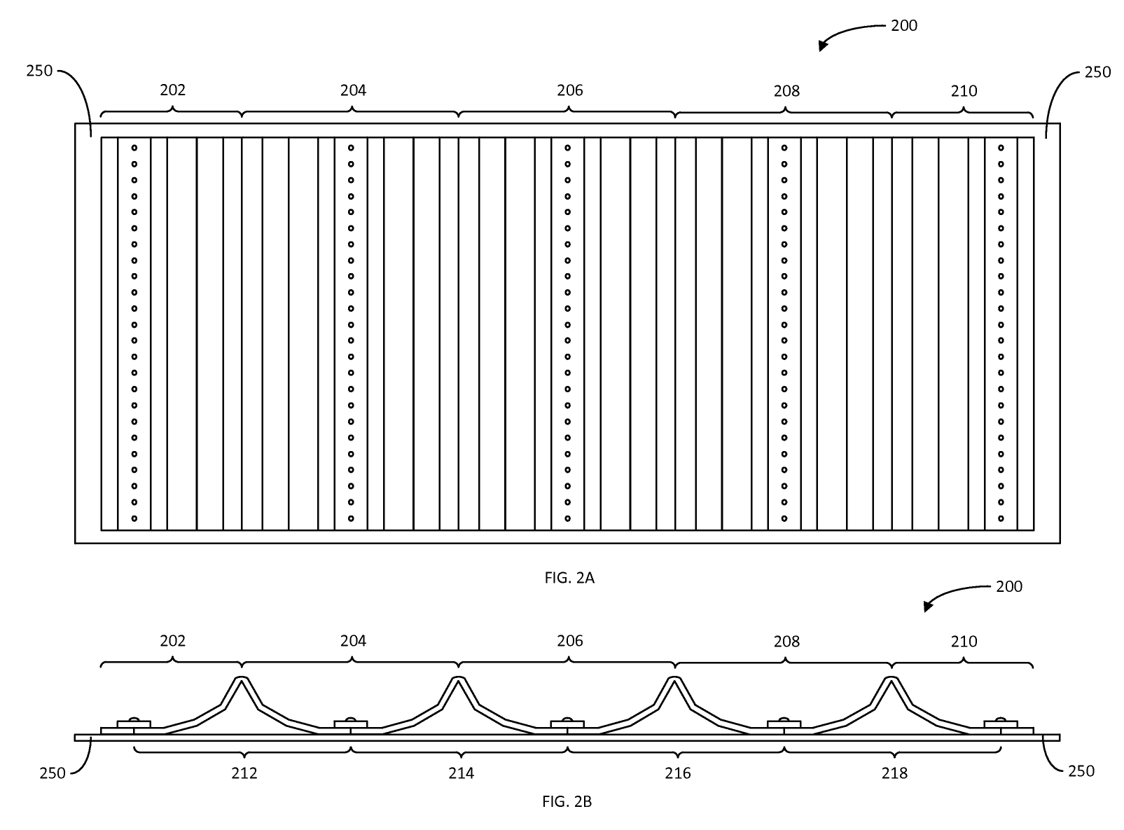

FIGS. 2A-2B illustrate top and side views of another exemplary advertising lightbox 200 in accordance with another aspect of the disclosure. The advertising lightbox 100, or at least the light array 112 and the reflector assembly 120, may also be arrayed in order to form larger light sources depending on the illumination requirements. In this example, the advertising lightbox 200 comprises a plurality of light sources 202, 204, 206, 208, and 210 arrayed along the lateral axis of each of the sources. Further, in accordance with this example, the light sources 204, 206, and 208 are configured similar to advertising lightbox 100, and light sources 202 and 210 are configured similar to essentially half of the advertising lightbox 100. It shall be understood that the array of light sources may be configured differently than advertising lightbox 100, and may be different from one another in the array depending on the desired illumination effect. Additionally, it shall be understood that the light sources may also be arrayed in the longitudinal direction.

The light sources 202 to 210 may be disposed on a common metallic back plate 250. In terms of ease of manufacturing, a half of a reflector of one of the light sources may be integral with an adjacent half of a reflector of an adjacent light source. For example, the only half reflector of light source 202 may be integral with the left half reflector of light source 204, as indicated by the reference number 212. Similarly, the right half reflector of light source 204 may be integral with the left half reflector of light source 206, as indicated by the reference number 214. Likewise, the right half reflector of light source 206 may be integral with the left half reflector of light source 208, as indicated by the reference number 216. And, the right half reflector of light source 208 may be integral with the only half reflector of light source 210, as indicated by the reference number 218. Although a transparent or translucent panel above the light sources is not shown in this example, it shall be understood that such a panel may be provided that spans the length and width of the light source array of advertising lightbox 200.

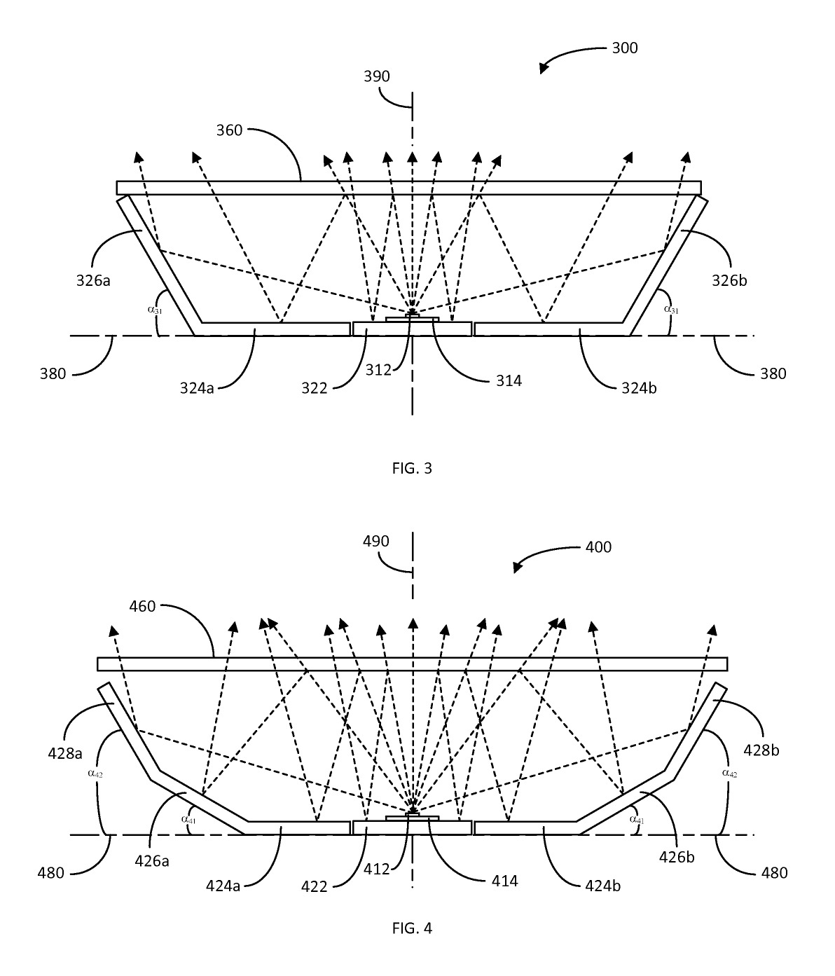

FIG. 3 illustrates a side view of another exemplary advertising lightbox 300 in accordance with another aspect of the disclosure. The reflectors of the advertising lightbox described herein may be configured with different number of sections to achieve the desired illumination effect. More specifically, the advertising lightbox 300 comprises an array of LEDs 312 (only one shown in this figure) disposed on an elongated plate 314. The longitudinal (horizontal) axis of the LED array 312 extends perpendicular into and out of the drawing sheet, in a similar manner as in advertising lightbox 100.

The advertising lightbox 300 further comprises a reflector including planar sections 322, 324a-b, and 326a-b elongated substantially parallel with the longitudinal (horizontal) axis of the LED array 312. The LED array 312 including the elongated plate 314 is disposed partially over the elongated planar section 322 of the reflector. The elongated planar sections 324a-b are situated on both sides of section 322 in a lateral axis direction 380. The elongated planar sections 322 and 324a-b are oriented substantially horizontal (i.e., their respective angles of inclination are substantially zero (0)).

The elongated planar sections 326a-b are situated on both sides of sections 324a-b in the outward (negative and positive) lateral directions 380, respectively. The elongated planar sections 326a-b are inclined in the positive vertical axis direction 390 along the outward lateral axis direction 380 with a particular angle of inclination α₃₁. The sections 322, 324a-b, and 326a-b of the reflector may be separate from each other, may be mechanically coupled to each other, or may be integral with each other. Although, in this example, the reflector is configured symmetrically about the longitudinal and vertical axes, it shall be understood that the reflector may be configured in an asymmetrical manner depending on the desired illumination effect.

The advertising lightbox 300 further comprises a transparent or translucent panel 360 situated above the LED array 312 and the reflector. In this example, the panel 360 is substantially planar and oriented in a substantially horizontal manner (i.e., substantially parallel with the lateral axis 380). Although not shown, the panel 360 may include advertising indicia and/or graphics. The LED array 312 and the reflector are configured to illuminate the panel 360 with a desired illumination effect.

As in the previous embodiment, an upper portion of the sections 326a-b are configured to perform primary reflection of the light emitted by the LED array 312, and direct the reflected light towards the panel 360 in defined directions to achieve the desired illumination effect. A lower portion of the sections 326a-b are configured to perform secondary reflection of the light originating from the LED array 312 by way of the panel 360, and direct the reflected light towards the panel 360 in defined directions to achieve the desired illumination effect. The other sections 322 and 324a-b of the reflector are configured to perform secondary reflection of the light originating from the LED array 312 by way of the panel 360, and direct the reflected light towards the panel 360 in defined directions to achieve the desired illumination effect.

FIG. 4 illustrates a side view of another exemplary advertising lightbox 400 in accordance with another aspect of the disclosure. The advertising lightbox 400 is another example of a reflector with different number of sections to achieve the desired illumination effect. More specifically, the advertising lightbox 400 comprises an array of LEDs 412 (only one shown in this figure) disposed on an elongated plate 414. The longitudinal (horizontal) axis of the LED array 412 extends perpendicular into and out of the drawing sheet, in a similar manner as in advertising light boxes 100 and 300.

The advertising lightbox 400 further comprises a reflector including planar sections 422, 424a-b, 426a-b, and 428a-b elongated substantially parallel with the longitudinal (horizontal) axis of the LED array 412. The LED array 412 including the elongated plate 414 is disposed partially over the elongated planar section 422 of the reflector. The elongated planar sections 424a-b are situated on both sides of section 422 in a lateral axis direction 480. The elongated planar sections 422 and 424a-b are oriented substantially horizontal (i.e., their respective angles of inclination are substantially zero (0)).

The elongated planar sections 426a-b are situated on both sides of sections 424a-b in the outward (negative and positive) lateral directions 480, respectively. The elongated planar sections 426a-b are inclined in the positive vertical axis direction 490 along the outward lateral directions 480 with an angle of inclination α₄₁. Similarly, the elongated planar sections 428a-b are situated on both sides of sections 426a-b in the outward lateral directions 480, respectively. The elongated planar sections 428a-b are inclined in the positive vertical axis direction 490 along the outward lateral directions 480 with an angle of inclination α₄₂.

In this example, the angle of inclination α₄₂ of sections 428a-b is greater than the angle of inclination c′41 of sections 426a-b. The sections 422, 424a-b, 426a-b, and 428a-b of the reflector may be separate from each other, may be mechanically coupled to each other, or may be integral with each other. Although, in this example, the reflector is configured symmetrically about the longitudinal and vertical axes, it shall be understood that the reflector may be configured in an asymmetrical manner depending on the desired illumination effect.

The advertising lightbox 400 further comprises a transparent or translucent panel 460 situated above the LED array 412 and the reflector. In this example, the panel 460 is substantially planar and oriented in a substantially horizontal manner (i.e., substantially parallel with the lateral axis 480). Although not shown, the panel 460 may include advertising indicia and/or graphics. The LED array 412 and the reflector are configured to illuminate the panel 460 with a desired illumination effect.

As in the previous embodiments, an upper portion of the sections 428a-b are configured to perform primary reflection of the light emitted by the LED array 412, and direct the reflected light towards the panel 460 in defined directions to achieve the desired illumination effect. A lower portion of the sections 428a-b are configured to perform secondary reflection of the light originating from by the LED array 412 by way of the panel 460, and direct the reflected light towards the panel 460 in defined directions to achieve the desired illumination effect. The other sections 422, 424a-b, and 426a-b of the reflector are configured to perform secondary reflection of the light originating from the LED array 412 by way of the panel 460, and direct the reflected light towards the panel 460 in defined directions to achieve the desired illumination effect.

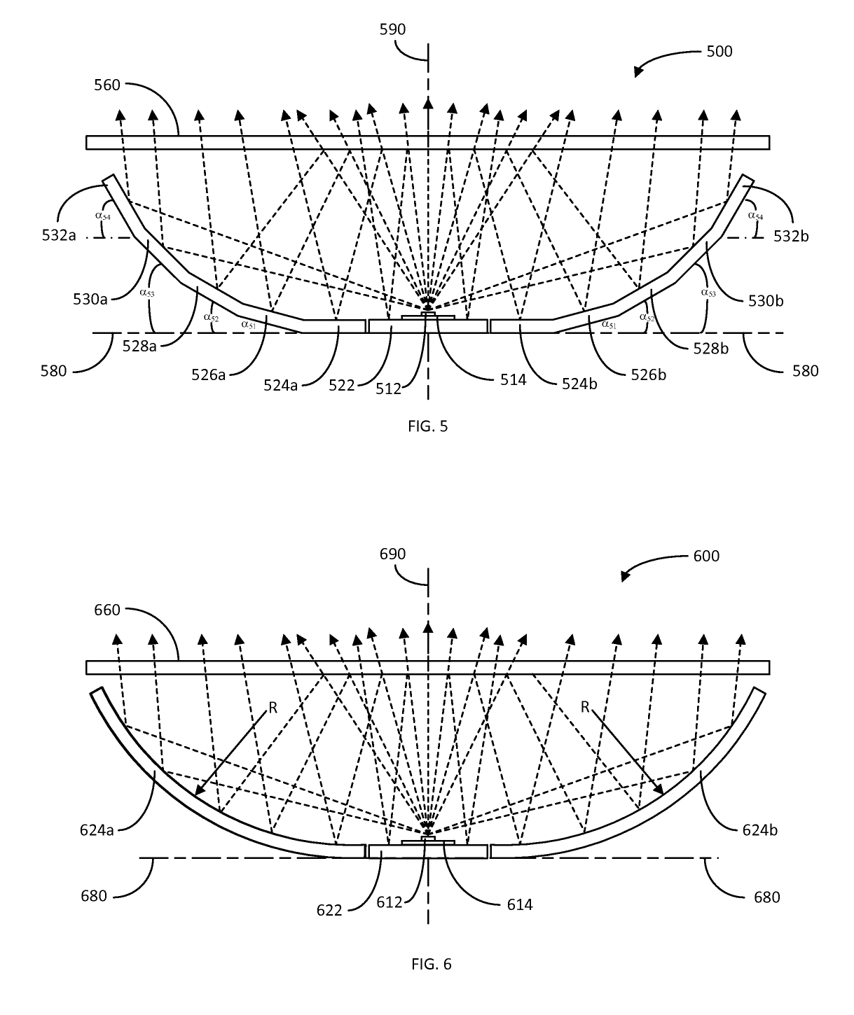

FIG. 5 illustrates a side view of another exemplary advertising lightbox 500 in accordance with another aspect of the disclosure. The advertising lightbox 500 is another example of a reflector with different number of sections to achieve a desired illumination effect. More specifically, the advertising lightbox 500 comprises an array of LEDs 512 (only one shown in this figure) disposed on an elongated plate 514. The longitudinal (horizontal) axis of the LED array 512 extends perpendicular into and out of the drawing sheet, in a similar manner as in the previous advertising light boxes.

The advertising lightbox 500 further comprises a reflector including planar sections 522, 524a-b, 526a-b, 528a-b, 530a-b, and 532a-b elongated substantially parallel with the longitudinal (horizontal) axis of the LED array 512. The LED array 512 and the elongated plate 514 are disposed partially over the elongated planar section 522 of the reflector. The elongated planar sections 524a-b are situated on both sides of section 522 in a lateral axis direction 580. The elongated planar sections 522 and 524a-b are oriented substantially horizontal (i.e., their respective angles of inclination are substantially zero (0)).

The elongated planar sections 526a-b are situated on both sides of sections 524a-b in the outward lateral direction 580, respectively. The elongated planar sections 526a-b are inclined in the positive vertical axis direction 590 along the outward lateral direction 580 with an angle of inclination α₅₁. Similarly, the elongated planar sections 528a-b are situated on both sides of sections 526a-b in the outward lateral direction 580, respectively. The elongated planar sections 528a-b are inclined in the positive vertical axis direction 590 along the outward lateral direction 580 with an angle of inclination α₅₂.

The elongated planar sections 530a-b are situated on both sides of sections 528a-b in the outward lateral direction 580, respectively. The elongated planar sections 530a-b are inclined in the positive vertical axis direction 590 along the outward lateral direction 580 with an angle of inclination α₅₃. Similarly, the elongated planar sections 532a-b are situated on both sides of sections 530a-b in the outward lateral direction 580, respectively. The elongated planar sections 532a-b are inclined in the positive vertical axis direction 590 along the outward lateral direction 580 with an angle of inclination α₅₄.

In this example, the angle of inclination α₅₂ of sections 528a-b is greater than the angle of inclination α₅₁ of sections 526a-b; the angle of inclination α₅₃ of sections 530a-b is greater than the angle of inclination α₅₂ of sections 528a-b; and the angle of inclination α₅₄ of sections 532a-b is greater than the angle of inclination α₅₃ of sections 530a-b. The sections 522, 524a-b, 526a-b, 528a-b, 530a-b, and 532a-b of the reflector may be separate from each other, may be mechanically coupled to each other, or may be integral with each other. Although, in this example, the reflector is configured symmetrically about the longitudinal (horizontal) and vertical axes, it shall be understood that the reflector may be configured in an asymmetrical manner depending on the desired illumination effect.

The advertising lightbox 500 further comprises a transparent or translucent panel 560 situated above the LED array 512 and the reflector. In this example, the panel 560 is substantially planar and oriented in a substantially horizontal manner (i.e., substantially parallel with the lateral axis 580). Although not shown, the panel 560 may include advertising indicia and/or graphics. The LED array 512 and the reflector are configured to illuminate the panel 560 with a desired illumination effect. In this example, the sections 532a-b are entirely configured to perform primary reflection of the light emitted by the LED array 512, and direct the reflected light towards the panel 560 in defined directions to achieve the desired illumination effect.

An upper portion of sections 530a-b are configured to perform primary reflection of the light emitted by the LED array 512, and direct the reflected light towards the panel 560 in defined directions to achieve the desired illumination effect. A lower portion of sections 530a-b are configured to perform secondary reflection of the light originating from the LED array 512 by way of the panel 560, and direct the reflected light towards the panel 560 in defined directions to achieve the desired illumination effect.

The other sections 522, 524a-b, 526a-b, and 528a-b of the reflector are configured to perform secondary reflection of the light received from the LED array 512 by way of the panel 560, and direct the reflected light towards the panel 560 in defined directions to achieve the desired illumination effect.

FIG. 6 illustrates a side view of another exemplary advertising lightbox 600 in accordance with another aspect of the disclosure. As the number of planer sections of the reflector increases, the reflector approaches a smoothly curved reflector. Accordingly, advertising lightbox 600 comprises such a reflector. In particular, the advertising lightbox 600 comprises an array of LEDs 612 (only one shown in this figure) disposed on an elongated planar plate 614. The longitudinal (horizontal) axis of the LED array 612 extends perpendicular into and out of the drawing sheet, in a similar manner as in the previous advertising light boxes.

The advertising lightbox 600 further comprises a reflector including planar section 622 and curved sections 624a-b, both elongated substantially parallel with the longitudinal (horizontal) axis of the LED array 612. The LED array 612 and the elongated planar plate 614 are disposed partially over the elongated planar section 622 of the reflector. The elongated curved sections 624a-b are situated on both sides of section 622 in a lateral axis direction 680. The elongated planar section 622 is oriented substantially horizontal (i.e., its angle of inclination is substantially zero (0)). The elongated curved sections 624a-b are situated on both sides of section 622 in the outward lateral direction 680, respectively. The elongated curved sections 624a-b are curved in the positive vertical axis direction 690 along the outward lateral axis directions 680 with a radius of curvature of R.

The advertising lightbox 600 further comprises a transparent or translucent panel 660 situated above the LED array 612 and the reflector. In this example, the panel 660 is substantially planar and oriented in a substantially horizontal manner (i.e., substantially parallel with the lateral axis 680). Although not shown, the panel 660 may include advertising indicia and/or graphics. The LED array 612 and the reflector are configured to illuminate the panel 660 with a desired illumination effect.

In this example, an upper portion of curved sections 624a-b are configured to perform primary reflection of the light emitted by the LED array 612, and direct the reflected light towards the panel 660 in defined directions to achieve the desired illumination effect. A lower portion of sections 624a-b are configured to perform secondary reflection of the light originating from the LED array 612 by way of the panel 660, and direct the reflected light towards the panel 660 in defined directions to achieve the desired illumination effect. The other section 622 of the reflector is configured to perform secondary reflection of the light originating from the LED array 612 by way of the panel 660, and direct the reflected light towards the panel 660 in defined directions to achieve the desired illumination effect.

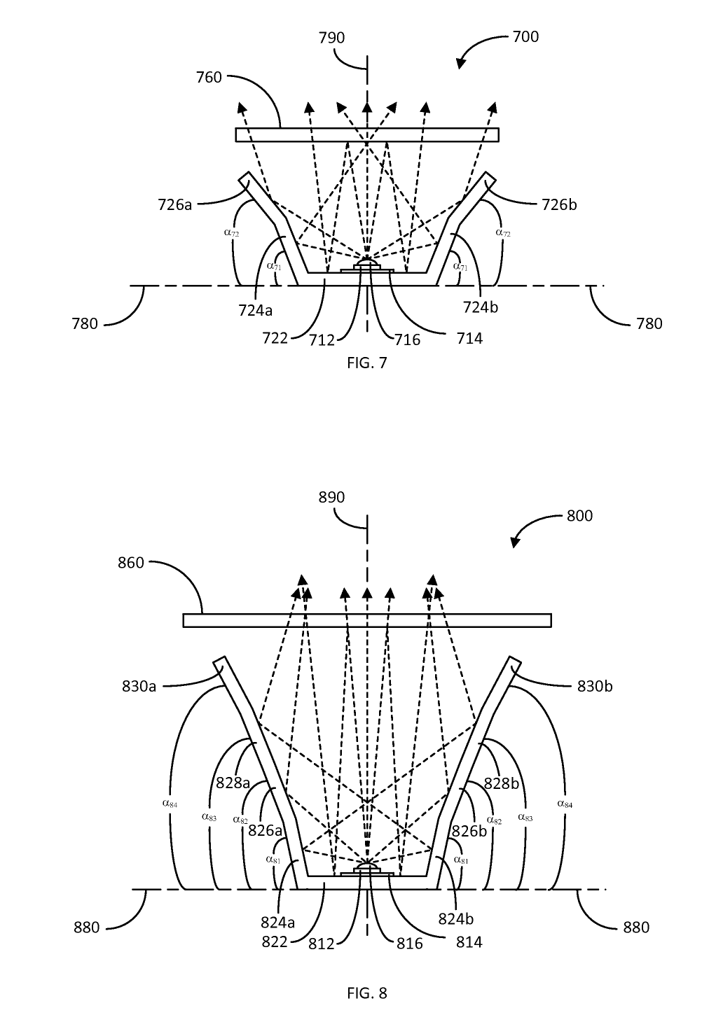

FIG. 7 illustrates a side view of another exemplary advertising lightbox 700 in accordance with another aspect of the disclosure. In the previous examples, the angles of inclination of the elongated planar sections of the reflectors increased along the outward lateral direction. In this example, the angles of inclination of the elongated planar sections of the reflectors decrease along the outward lateral direction. Additionally, a lens is formed above the LED array to change the angle of dispersion of the light emitted by the LED array.

In particular, the advertising lightbox 700 comprises an array of LEDs 712 (only one shown in this figure) disposed over an elongated planar plate 714. The longitudinal (horizontal) axis of the LED array 712 extends perpendicular into and out of the drawing sheet, in a similar manner as in the previous advertising lightbox. The advertising lightbox 700 further comprises a lens 716 formed over one or more LEDs of the LED array 712. The lens 716 has the effect of changing the maximum angle of dispersion of the LED array 712. For example, the lens 716 may change the maximum angle of dispersion from 120 degrees to 170 degrees. Accordingly, the lens 716 should be taken into consideration in the design of the reflector in order to achieve the desired illumination effect.

The advertising lightbox 700 further comprises a reflector including planar sections 722, 724a-b, and 726a-b elongated substantially parallel with the longitudinal (horizontal) axis of the LED array 712. The LED array 712, including the elongated planar plate 714 and the lens 716, is disposed partially over the elongated planar section 722 of the reflector. The elongated planar sections 722 is oriented substantially horizontal (i.e., its respective angle of inclination is substantially zero (0)).

The elongated planar sections 724a-b are situated on both sides of section 722 in the outward lateral direction 780, respectively. The elongated planar sections 724a-b are inclined in the positive vertical axis direction 790 along the outward lateral direction 780 with an angle of inclination α₇₁. Similarly, the elongated planar sections 726a-b are situated on both sides of sections 724a-b in the outward lateral direction 780, respectively. The elongated planar sections 726a-b are inclined in the positive vertical axis direction 790 along the outward lateral direction 780 with an angle of inclination α₇₂.

In this example, the angle of inclination α₇₂ of sections 726a-b is less than the angle of inclination α₇₁ of sections 724a-b. The sections 722, 724a-b, and 726a-b of the reflector may be separate from each other, may be mechanically coupled to each other, or may be integral with each other. Although, in this example, the reflector is configured symmetrically about the longitudinal (horizontal) and vertical axes, it shall be understood that the reflector may be configured in an asymmetrical manner depending on the desired illumination effect.

The advertising lightbox 700 further comprises a transparent or translucent panel 760 situated above the LED array 712 and the reflector. In this example, the panel 760 is substantially planar and oriented in a substantially horizontal manner (i.e., substantially parallel with the lateral axis 780). Although not shown, the panel 760 may include advertising indicia and/or graphics. The LED array 712 and the reflector are configured to illuminate the panel 760 with a desired illumination effect. In this example, the sections 726a-b are entirely configured to perform primary reflection of the light emitted by the LED array 712, and direct the reflected light towards the panel 760 in defined directions to achieve the desired illumination effect.

An upper portion of sections 724a-b are configured to perform primary reflection of the light emitted by the LED array 712, and direct the reflected light towards the panel 760 in defined directions to achieve the desired illumination effect. A lower portion of sections 724a-b are configured to perform secondary reflection of the light emitted originating from the LED array 712 by way of the panel 760, and direct the reflected light towards the panel 760 in defined directions to achieve the desired illumination effect. The other section 722 of the reflector is configured to perform secondary reflection of the light originating from the LED array 712 by way of the panel 760, and direct the reflected light towards the panel 760 in defined directions to achieve the desired illumination effect.

FIG. 8 illustrates a side view of another exemplary advertising lightbox 800 in accordance with another aspect of the disclosure. Similar to the previous example, the angles of inclination of the elongated planar sections of the reflector of advertising lightbox 800 decrease in the outward lateral direction. However, advertising lightbox 800 has more sections than the previous advertising lightbox 700. Additionally, advertising lightbox 800 includes a lens over one or more LEDs of the LED array.

In particular, the advertising lightbox 800 comprises an array of LEDs 812 (only one shown in this figure) disposed over an elongated planar plate 814. The longitudinal (horizontal) axis of the LED array 812 extends perpendicular into and out of the drawing sheet, in a similar manner as in the previous advertising lightbox. The advertising lightbox 800 further comprises a lens 816 formed over one or more LEDs of the LED array 812. Similar to the previous embodiment, the lens 816 has the effect of changing the maximum angle of dispersion of the LED array 812.

The advertising lightbox 800 further comprises a reflector including planar sections 822, 824a-b, 826a-b, 828a-b, and 830a-b elongated substantially parallel with the longitudinal (horizontal) axis of the LED array 812. The LED array 812, including the elongated planar plate 814 and the lens 816, is disposed partially over the elongated planar section 822 of the reflector. The elongated planar sections 822 is oriented substantially horizontal (i.e., its respective angle of inclination is substantially zero (0)).

The elongated planar sections 824a-b are situated on both sides of section 822 in the outward lateral direction 880, respectively. The elongated planar sections 824a-b are inclined in the positive vertical axis direction 890 along the outward lateral direction 880 with an angle of inclination c′81. Similarly, the elongated planar sections 826a-b are situated on both sides of sections 824a-b in the outward lateral direction 880, respectively. The elongated planar sections 826a-b are inclined in the positive vertical axis direction 890 along the outward lateral direction 880 with an angle of inclination α₈₂. In a like manner, the elongated planar sections 828a-b are situated on both sides of sections 826a-b in the outward lateral direction 880, respectively. The elongated planar sections 828a-b are inclined in the positive vertical axis direction 890 along the outward lateral direction 880 with an angle of inclination α₈₃. Also, in a similar manner, the elongated planar sections 830a-b are situated on both sides of sections 828a-b in the outward lateral direction 880, respectively. The elongated planar sections 830a-b are inclined in the positive vertical axis direction 890 along the outward lateral direction 880 with an angle of inclination α₈₄.

In this example, the angle of inclination α₈₂ of sections 826a-b is less than the angle of inclination α₈₁ of sections 824a-b; the angle of inclination α₈₃ of sections 828a-b is less than the angle of inclination α₈₂ of sections 826a-b; and the angle of inclination α₈₄ of sections 830a-b is less than the angle of inclination α₈₃ of sections 828a-b. The sections 822, 824a-b, 826a-b, 828a-b, and 830a-b of the reflector may be separate from each other, may be mechanically coupled to each other, or may be integral with each other. Although, in this example, the reflector is configured symmetrically about the longitudinal (horizontal) and vertical axes, it shall be understood that the reflector may be configured in an asymmetrical manner depending on the desired illumination effect.

The advertising lightbox 800 further comprises a transparent or translucent panel 860 situated above the LED array 812 and the reflector. In this example, the panel 860 is substantially planar and oriented in a substantially horizontal manner (i.e., substantially parallel with the lateral axis 880). Although not shown, the panel 860 may include advertising indicia and/or graphics. The LED array 812 and the reflector are configured to illuminate the panel 860 with a desired illumination effect. In this example, sections 826a-b, 828a-b, and 830a-b are entirely configured to perform primary reflection of the light emitted by the LED array 812, and direct the reflected light towards the panel 860 in defined directions to achieve the desired illumination effect.

An upper portion of sections 824a-b are configured to perform primary reflection of the light emitted by the LED array 812, and direct the reflected light towards the panel 860 by way of other sections (e.g., sections 828a-b and/or 830a-b) in defined directions to achieve the desired illumination effect. A lower portion of sections 824a-b are configured to perform secondary reflection of the light originating from the LED array 812 by way of the panel 860, and direct the reflected light towards the panel 860 in defined directions to achieve the desired illumination effect. The other section 822 of the reflector is configured to perform secondary reflection of the light originating from the LED array 812 by way of the panel 860, and direct the reflected light towards the panel 860 in defined directions to achieve the desired illumination effect.

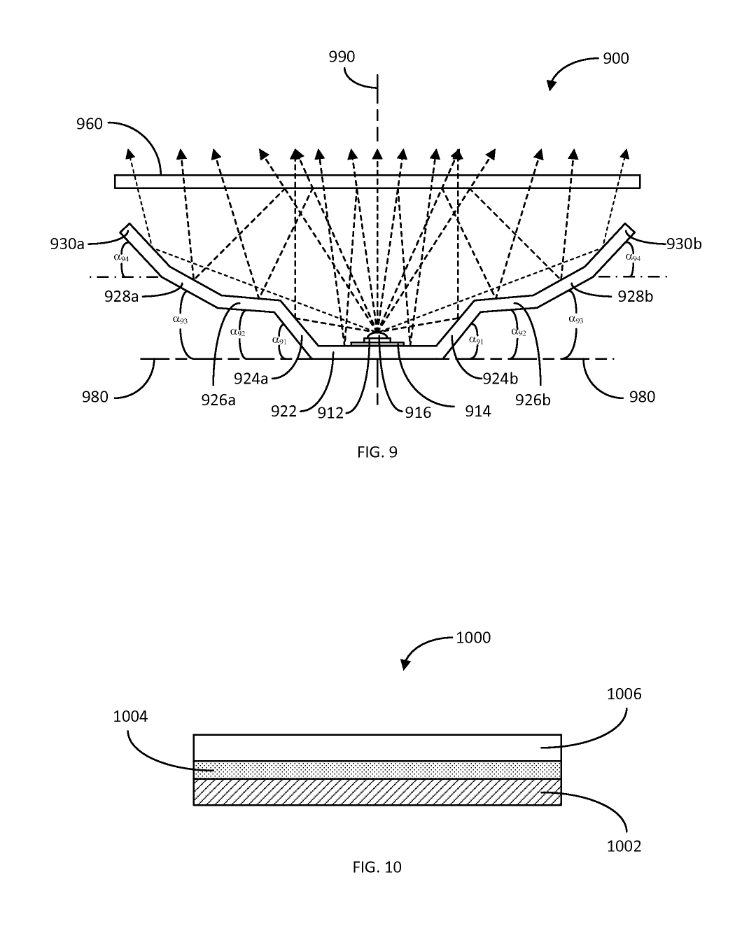

FIG. 9 illustrates a side view of another exemplary advertising lightbox 900 in accordance with another aspect of the disclosure. In some of the previous embodiments, the angles of inclination of the elongated planar sections of the reflector increased along the outward lateral direction. In other embodiments, the angles of inclination of the elongated planar sections of the reflector decreased along the outward lateral direction. In this embodiment, the angles of inclination of the elongated planar sections of the reflector both decrease and increase in the outward lateral direction.

In particular, the advertising lightbox 900 comprises an array of LEDs 912 (only one shown in this figure) disposed over an elongated planar plate 914. The longitudinal (horizontal) axis of the LED array 912 extends perpendicular into and out of the drawing sheet, in a similar manner as in the previous advertising light boxes. The advertising lightbox 900 further comprises a lens 916 formed over one or more LEDs of the LED array 912. Similar to the previous embodiment, the lens 916 has the effect of changing the maximum angle of dispersion of the LED array 912.

The advertising lightbox 900 further comprises a reflector including planar sections 922, 924a-b, 926a-b, 928a-b, and 930a-b elongated substantially parallel with the longitudinal (horizontal) axis of the LED array 912. The LED array 912, including the elongated planar plate 914 and the lens 916, is disposed partially over the elongated planar section 922 of the reflector. The elongated planar section 922 is oriented substantially horizontal or parallel with the lateral axis 980 (i.e., its respective angle of inclination is substantially zero (0)).

The elongated planar sections 924a-b are situated on both sides of section 922 in the outward lateral direction 980, respectively. The elongated planar sections 924a-b are inclined in the positive vertical axis direction 990 along the outward lateral direction 980 with an angle of inclination α₉₁. Similarly, the elongated planar sections 926a-b are situated on both sides of sections 924a-b in the outward lateral direction 980, respectively. The elongated planar sections 926a-b are inclined in the positive vertical axis direction 990 along the outward lateral axis direction 980 with an angle of inclination α₉₂. In a like manner, the elongated planar sections 928a-b are situated on both sides of sections 926a-b in the outward lateral direction 980, respectively. The elongated planar sections 928a-b are inclined in the positive vertical axis direction 990 along the outward lateral axis direction 980 with an angle of inclination α₉₃. Also, in a similar manner, the elongated planar sections 930a-b are situated on both sides of sections 928a-b in the outward lateral direction 980, respectively. The elongated planar sections 930a-b are inclined in the positive vertical axis direction 990 along the outward lateral axis direction 980 with an angle of inclination α₉₄.

In this example, the angle of inclination α₉₂ of sections 926a-b is less than the angle of inclination α₉₁ of sections 924a-b; the angle of inclination α₉₃ of sections 928a-b is greater than the angle of inclination α₉₂ of sections 926a-b; and the angle of inclination α₉₄ of sections 930a-b is greater than the angle of inclination α₉₃ of sections 928a-b. The sections 922, 924a-b, 926a-b, 928a-b, and 930a-b of the reflector may be separate from each other, may be mechanically coupled to each other, or may be integral with each other. Although, in this example, the reflector is configured symmetrically about the longitudinal (horizontal) and vertical axes, it shall be understood that the reflector may be configured in an asymmetrical manner depending on the desired illumination effect.

The advertising lightbox 900 further comprises a transparent or translucent panel 960 situated above the LED array 912 and the reflector. In this example, the panel 960 is substantially planar and oriented in a substantially horizontal manner (i.e., substantially parallel with the lateral axis 980). The LED array 912 and the reflector are configured to illuminate the panel 960 with a desired illumination effect. In this example, respective upper portions of sections 924a-b, and 930a-b are configured to perform primary reflection of the light emitted by the LED array 912, and direct the reflected light towards the panel 960 in defined directions to achieve the desired illumination effect. The remaining portions, if any, of sections 924a-b, and 930a-b are configured to perform secondary reflection of the light originating from the LED array 912 by way of the panel 960, and direct the reflected light towards the panel 960 in defined directions to achieve the desired illumination effect.

The other sections 922, 926a-b, and 928a-b of the reflector is configured to perform secondary reflection of the light originating from the LED array 912 by way of the panel 960, and direct the reflected light towards the panel 960 in defined directions to achieve the desired illumination effect.

FIG. 10 illustrates a cross-sectional side view of an exemplary reflector section 1000 in accordance with another aspect of the disclosure. The reflector section 1000 may be a more detailed implementation of any reflector section previously discussed. In particular, the reflector section 1000 comprises a lower metallization layer 1002, an adhesive layer 1004 disposed over the metallization layer 1002, and a reflective dielectric layer 1006 disposed over the adhesive layer 1004. The metallization layer 1002 serves to provide structural integrity to the reflector section, and serves as a heat sink for fire prevention purposes. The metallization layer 1002 may be comprised of aluminum (e.g., 6063-T5 aluminum plate). The adhesive layer 1004 binds the reflective dielectric layer 1006 to the metallization layer 1002. The reflective dielectric layer 1006 performs reflection of incident light as discussed with reference to the previous embodiments. The reflective dielectric layer 1006 may be comprised of polyethylene terephthalate (PET).

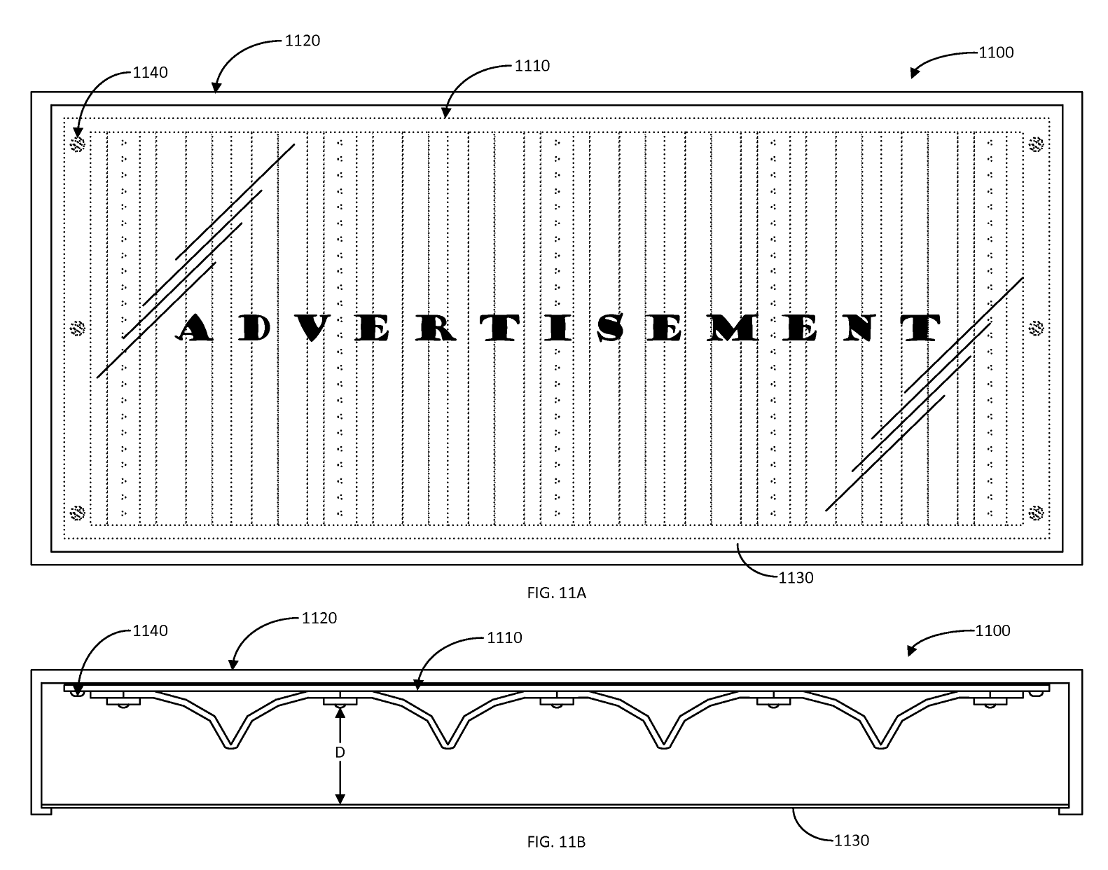

FIGS. 11A-11B illustrate front and top views of an exemplary advertising lightbox 1100 in accordance with another aspect of the disclosure. The advertising lightbox 1100 comprises a light source 1110, a housing 1120, an advertisement panel 1130, and a plurality of fasteners 1140 for mechanically securing the light source 1110 to the back side of the housing 1120.

The light source 1110 may comprise an array of any of the light sources previously discussed. In this example, the light source 1110 comprises a plurality of light sources arrayed along the lateral axis of each light source. It shall be understood that the light source may comprise a plurality of light sources arrayed in the longitudinal axis of the LED array, or arrayed in both the longitudinal and lateral axes based on the desired lighting need and effect.

The advertisement panel 1130 may be transparent or translucent, and may include advertising indicia and graphics based on the desired advertising concept. The advertisement panel 1130 is mechanically secured to a front part of the housing 1120 in a manner that the advertisement panel 1130 is oriented in substantially a vertical manner. The rear side of the advertisement panel 1130 is configured to receive the light emitted from the light source 1110. The light source 1110 is configured to illuminate the advertisement panel in order to achieve the desired illumination effect, as previously discussed.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. An advertising lightbox, comprising:
a transparent or translucent panel, wherein the transparent or translucent panel includes advertising indicia, advertising graphics, or advertising indicia and graphics;
a plurality of light emitting diodes (LEDs) arrayed along a longitudinal axis, wherein the LED array is configured to direct light towards the transparent or translucent panel;
a reflector comprising a plurality of planar sections elongated substantially parallel with the longitudinal axis of the LED array, wherein the reflector is configured to reflect light from the LED array towards the transparent or translucent panel; and
a plurality of lenses disposed over respective LEDs of the array, wherein the plurality of lenses are configured to increase a maximum angle of dispersion of the light emitted by the respective LEDs.

2. The advertising lightbox of claim 1, wherein a first subset of one or more of the elongated planar sections of the reflector is configured to perform primary reflection of light received directly from the LED array.

3. The advertising lightbox of claim 2, wherein a second subset of one or more of the elongated planar sections of the reflector is configured to perform secondary reflection of light received from the LED array by way of the transparent or translucent panel.

4. The advertising lightbox of claim 2, wherein one or more of the elongated planar sections in the first set comprises a first region configured to perform primary reflection of light received directly from the LED array, and a second region configured to perform secondary reflection of light received from the LED array by way of the transparent or translucent panel.

5. The advertising lightbox of claim 1, wherein the LED array is configured to emit light symmetrically about a positive vertical axis substantially orthogonal with the longitudinal axis of the LED array.

6. The advertising lightbox of claim 5, wherein a first set of one or more of the elongated planar sections are respectively offset from the longitudinal axis of the LED array along a positive direction of a lateral axis that is substantially orthogonal to the longitudinal and positive vertical axes.

7. The advertising lightbox of claim 6, wherein the one or more elongated planar sections of the first set are inclined in the positive vertical axis direction along the positive lateral axis direction with one or more distinct angles of inclination, respectively.

8. The advertising lightbox of claim 7, wherein the distinct angles of inclination of more than one of the elongated planar sections in the first set progressively increase along the lateral axis direction.

9. The advertising lightbox of claim 7, wherein the distinct angles of inclination of more than one of the elongated planar sections in the first set progressively decrease along the lateral axis direction.

10. The advertising lightbox of claim 7, wherein the distinct angles of inclination of more than one of the elongated planar sections in the first set increase and decrease or decrease and increase along the lateral axis direction.

11. The advertising lightbox of claim 6, wherein a second set of one or more of the elongated planar sections are respectively offset from the longitudinal axis of the LED array along a negative direction of the lateral axis.

12. The advertising lightbox of claim 11, wherein the one or more elongated planar sections of the first set are inclined in the positive vertical axis direction along the positive lateral axis direction with a first set of one or more distinct angles of inclination, respectively.

13. The advertising lightbox of claim 12, wherein the one or more elongated planar sections of the second set are inclined in the positive vertical axis direction along the negative lateral axis direction with a second set of one or more distinct angles of inclination, respectively.

14. The advertising lightbox of claim 13, wherein the distinct angles of inclination of the first set are substantially the same as the distinct angles of inclination of the second set, respectively.

15. The advertising lightbox of claim 14, wherein the distinct angles of inclination of the elongated planar sections in the first and second sets progressively increase in the positive and negative lateral axis directions, respectively.

16. The advertising lightbox of claim 14, wherein the distinct angles of inclination of the elongated planar sections in the first and second sets progressively decrease in the positive and negative lateral axis directions, respectively.

17. The advertising lightbox of claim 14, wherein the distinct angles of inclination of the elongated planar sections in the first and second sets increase and decrease or decrease and increase in the positive and negative lateral axis directions, respectively.

18. The advertising lightbox of claim 1, wherein the LED array is disposed over at least one of the elongated planar sections of the reflector.

19. An advertising lightbox, comprising:
a transparent or translucent panel, wherein the transparent or translucent panel includes advertising indicia, advertising graphics, or advertising indicia and graphics;
an array of at least first, second and third adjacent light sources, wherein each of the light sources comprises:
a plurality of light emitting diodes (LED) arrayed along a longitudinal axis, wherein the LED array is configured to direct light towards the transparent or translucent panel; and
a reflector comprising a plurality of planar sections elongated substantially parallel with the longitudinal axis of the LED array, wherein the reflector is configured to reflect light from the LED array towards the transparent or translucent panel;
wherein the at least first, second, and third adjacent light sources are arrayed along a lateral axis, wherein a lateral left half of the reflector of the second light source is integral with a lateral right half of the reflector of the first light source, wherein a lateral right half of the reflector of the second light source is integral with a lateral left half of the reflector of the third light source, and wherein the lateral left half of the reflector of the second light source is separate from the lateral right half of the reflector of the second light source.

20. An advertising lightbox, comprising:
a transparent or translucent panel, wherein the transparent or translucent panel includes advertising indicia, advertising graphics, or advertising indicia and graphics;
a plurality of light emitting diodes (LED) arrayed along a longitudinal axis, wherein the LED array is configured to direct light towards the transparent or translucent panel;
a reflector comprising a plurality of curved sections elongated substantially parallel with the longitudinal axis of the LED array, wherein the reflector is configured to reflect light from the LED array towards the transparent or translucent panel; and
a plurality of lenses disposed over respective LEDs of the array, wherein the plurality of lenses are configured to increase a maximum angle of dispersion of the light emitted by the respective LEDs.

21. The advertising lightbox of claim 1, wherein at least one of the planar section comprises a light reflective layer attached to a metallic layer by way of an adhesive layer.

22. The advertising lightbox of claim 21, wherein the light reflective layer comprises polyethylene terephthalate (PET).
